(19) United States
(12) Patent Application Publication
(10) Pub. No.: US 2008/0320195 A1
(43) Pub. Date: Dec. 25, 2008

(54) Adapter for memory card

(75) Inventor: Cheng-Ju Lee, Taipei Hsien (TW)

Correspondence Address: BACON & THOMAS, PLLC, 625 SLATERS LANE, FOURTH FLOOR, ALEXANDRIA, VA, 22314-1176, US

(73) Assignee: Wistron Corporation, Taipei Hsien (TW)

(21) Appl. No.: 12/078,901

(22) Filed: Apr. 8, 2008

(30) Foreign Application Priority Data
Jun. 22, 2007 (TW) 096122636

(51) Int. Cl. G06F 13/00

(52) U.S. Cl. 710/301

(57) ABSTRACT

An adapter for a memory card comprises a housing, an adapter interface and a plurality of terminals. The housing comprises a slot for accepting a first memory card that is to be adapted. The adapter interface is connected to one side of the housing. The adapter interface corresponds to a connection interface of a second memory card, and the size of the second memory card is smaller than the first memory card. The plurality of terminals is disposed in the slot. One side of the plurality of terminals may be electrically connected to the adapter interface. When the first memory card is inserted into the slot, the plurality of terminals may be electrically connected to the first memory card, and the first memory card may be electrically connected to the adapter interface.

### BACKGROUND OF THE INVENTION

1. Field of the Invention

The present invention relates to an adapter for a memory card, and, more particularly, to an adapter for a memory card which is capable of adapting different types of first memory cards into a second memory card for portable electronic devices that support the second memory card interface.

2. Description of the Related Art

Because of technological growth, various small portable electronic devices (such as mobile phones, MP3 players, and digital cameras) have become very common products. Since all of these portable electronic devices tend to have several functions and smaller sizes, their corresponding memory cards are also tending toward smaller. Furthermore, there are many different memory card standards for different electronic devices. For example, the most common SD series memory cards are SD, Mini SD and Micro SD. Typical digital cameras or GPS units usually use SD memory cards as a storage media, and the Mini SD and Micro SD memory cards are usually for the mobile phones or MP3 players. Moreover, since the Micro SD memory card is currently the smallest, it is likely to become the next main storage media.

In order to transmit data to the portable electronic device via different types of memory cards, or to exchange data between two electronic devices supporting different memory card standards, a computer device is always required to serve as an intermediate media. First, the data stored in one memory card or an electronic device is transmitted into the computer via a transmission cable, and then the data is transmitted into a target electronic device via another transmission cable. This data transmission method requires two data transmission procedures, and cannot be performed without the computer device, which can be very inconvenient for a user who is in a hurry.

Therefore, it is desirable to provide an adapter for memory cards to mitigate and/or obviate the aforementioned problems.

### SUMMARY OF THE INVENTION

A main objective of the present invention is to provide an adapter for a memory card which is capable of adapting different types of first memory cards into a second memory card.

In order to achieve the above-mentioned objective, the adapter for a memory card of the present invention comprises a housing, an adapter interface and a plurality of terminals. The housing comprises a slot for accepting a first memory card that is to be adapted. The adapter interface is connected to one side of the housing. The adapter interface corresponds to a connection interface of a second memory card, and the size of the second memory card is smaller than the first memory card. The plurality of terminals is disposed in the slot. One side of the plurality of terminals may be electrically connected to the adapter interface. When the first memory card is inserted into the slot, the plurality of terminals may be electrically connected to the first memory card, and the first memory card may be electrically connected to the adapter interface.

The adapter for a memory card further comprises a first contacting spring portion and a second contacting spring portion for respectively electrically connecting to different types of first memory cards. The slot comprises a first containment slot and a second containment slot for accepting different types of first memory cards, a width of the first containment slot being smaller than a width of the second containment slot. Therefore, the adapter for a memory card can be suitable for different types of first memory cards.

Other objects, advantages, and novel features of the invention will become more apparent from the following detailed description when taken in conjunction with the accompanying drawings.

### BRIEF DESCRIPTION OF THE DRAWINGS

FIG. 1 is an internal structure drawing of an adapter for a memory card according to the present invention.

FIG. 2 shows the operation for the adapter for a memory card being electrically connected to a first memory card.

FIG. 3 is a schematic drawing of combining the adapter for a memory cards and a first memory card.

FIG. 4 is schematic drawing of combining the adapter for a memory card and another first memory card.

FIGS. 5(a), (b) are schematic drawings of contacts between a plurality of terminals and a first memory card.

FIG. 6 is schematic drawing of combining the adapter for a memory card and a portable electronic device.

### DETAILED DESCRIPTION OF THE PREFERRED EMBODIMENT

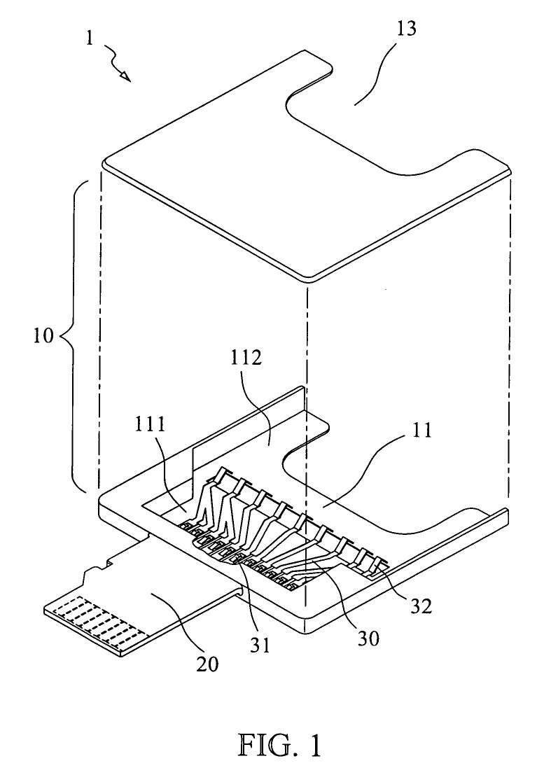

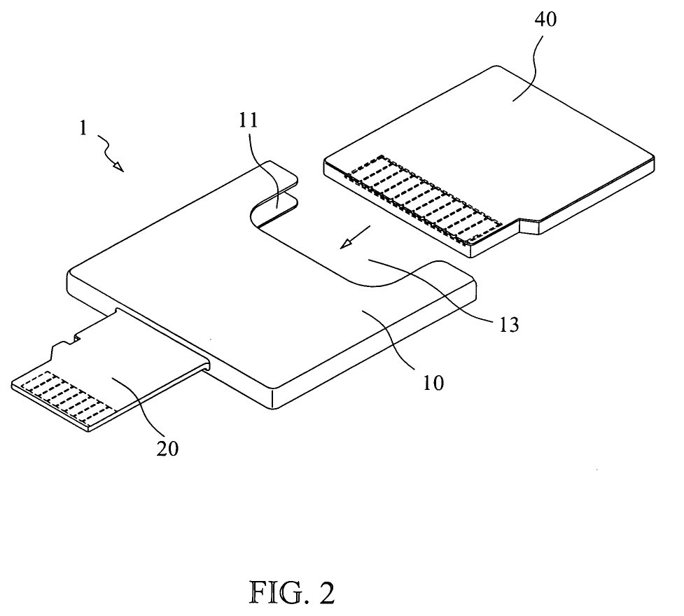

Please refer to FIG. 1 and FIG. 2. FIG. 1 is an internal structure drawing of an adapter for a memory card according to the present invention. FIG. 2 shows the operation for the adapter for a memory card being electrically connected to a first memory card. As shown in FIG. 1 and FIG. 2, an adapter 1 of the present invention for a memory card comprises a housing 10, an adapter interface 20 and a plurality of terminals 30. The housing 10 comprises a slot 11 for accepting a first memory card 40 that is to be adapted, and the adapter interface 20 is connected to one side of the housing 10. The adapter interface 20 corresponds to a connection interface of a second memory card, and the size of the second memory card is smaller than the size of the first memory card 40. The plurality of terminals 30 is composed of a plurality of metal springs. The plurality of terminals 30 is located in the slot 11, and one end of the plurality of terminals 30 is electrically connected to the adapter interface 20. When the first memory card 40 is inserted into the slot 11, the plurality of terminals 30 is electrically connected to the first memory card 40, and the first memory card 40 is electrically connected to the adapter interface 20. In this embodiment, the adapter interface 20 corresponds to the connection interface of a Micro SD memory card; therefore, the first memory card 40 can be directly supported on a portable electronic device that accepts the Micro SD memory card via the adapter 1. The housing 10 further comprises an indentation 13; when the first memory card 40 is inserted into the slot 11, part of the first memory card 40 can still be seen and so it is easy to remove. In the embodiment of the present invention, the housing 10 can be designed as a top and bottom case combination shown in FIG. 1, or as an integrated structure shown in FIG. 2, or any other suitable designs.

As shown in FIG. 1, the plurality of terminals 30 of the adapter 1 further comprises a first contact spring portion 31 and a second contact spring portion 32 for respectively electrically connecting to different types of first memory cards 40. The slot 11 of the adapter 1 comprises a first containment slot 111 and a second containment slot 112 for separately accepting different types of first memory cards 40; a width of the first containment slot 111 is smaller than a width of the second containment slot 112. The first contact spring portion 31 is disposed in the first containment slot 111, and the second contact spring portion 32 is disposed in the second containment slot 112.

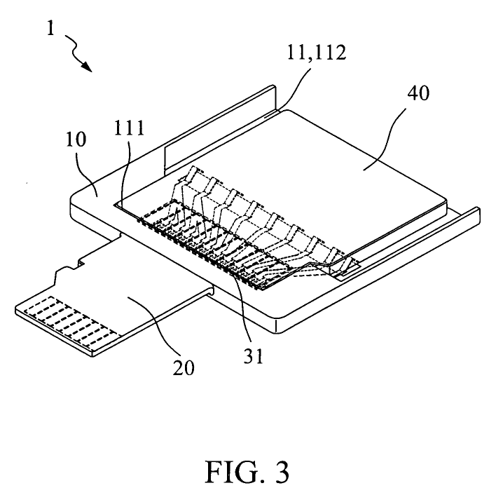

Please refer to FIG. 3. FIG. 3 is a schematic drawing of combining the adapter for a memory card and a first memory card. As shown in FIG. 3, when the first memory card 40 is inserted into the slot 11, since the width of the first containment slot 111 is equal in size to the first memory card 40, the first memory card 40 can engage with the slot 11 in a close fitting manner. However, the first memory card 40 may engage with the slot 11 in fastening manner or with other engaging methods. Subsequently, the connection interface of the first memory card 40 contacts and electrically connects with the first contact spring portion 31. In this embodiment, the first memory card 40 is a Mini SD memory card.

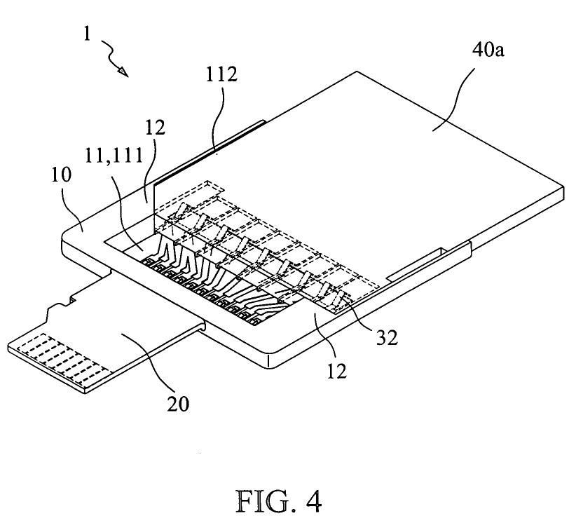

Please refer to FIG. 4. FIG. 4 is schematic drawing of combining the adapter for a memory card and another first memory card. As shown in FIG. 4, the housing 10 of the adapter 1 for a memory card further comprises a fool-proof structure 12, and the fool-proof structure 12 is located between the first containment slot 111 and the second containment slot 112. When a first memory card 40a is inserted into the adapter 1, the fool-proof structure 12 ensures the first memory card 40a remains in the second containment slot 112 so the connection interface of the first memory card 40a contacts and electrically connects with the second contact spring portion 32. Since the width of the second containment slot 112 equals the width of the first memory card 40a, the first memory card 40a can engage with the slot 11 in a close fitting manner. However, the first memory card 40a may engage with the slot 11 in fastening manner or other engaging methods. In this embodiment, the first memory card 40 is a SD memory card.

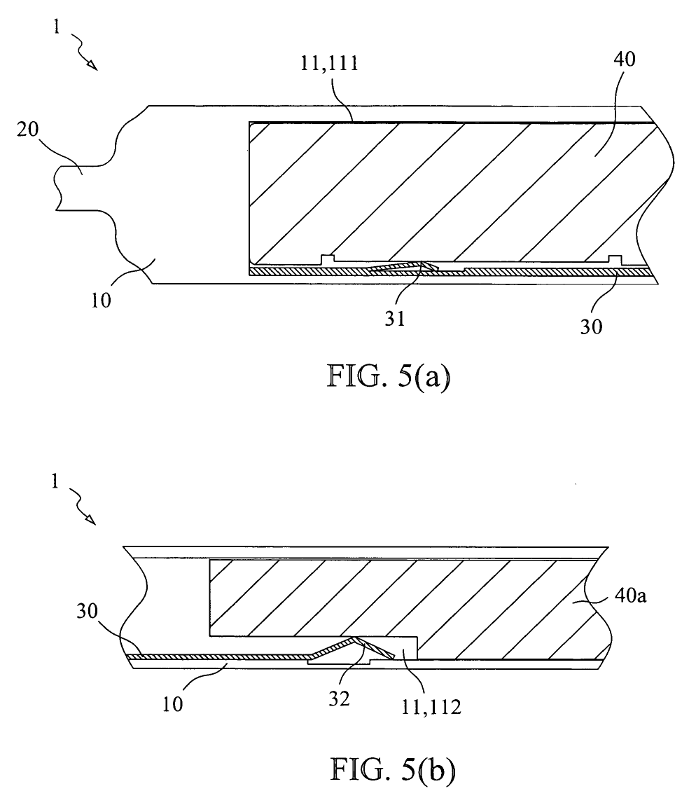

Please refer to FIGS. 5(a), (b). FIGS. 5(a), (b) are schematic drawings of contacts between a plurality of terminals and a first memory card. As shown in FIG. 5(a), when the first memory card 40 is inserted into the first containment slot 111 of the slot 11, since the first contact spring portion 31 has been bent upwards, the first contact spring portion 31 is electrically connected to and directly contacts with the connection interface of the first memory card 40. The first memory card 40 and the adapter interface 20 are also electrically connected to each other. Similarly, as shown in FIG. 5(b), when the first memory card 40a is inserted into the second containment slot 112 of the slot 11, since the second contact spring portion 32 has been bent upwards, the second contact spring portion 32 is electrically connected to and directly contacts with the connection interface of the first memory card 40a, and the first memory card 40a and the adapter interface 20 are also electrically connected to each other.

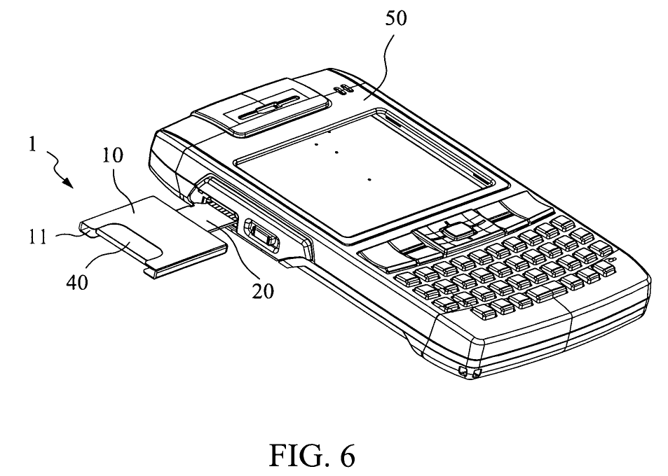

Please refer to FIG. 6. FIG. 6 is schematic drawing of combining the adapter for a memory card and a portable electronic device. As shown in FIG. 6, when the adapter 1 is used to support data transmission for the first memory card 40, the adapter interface 20 of the adapter 1 is inserted into the portable electronic device 50, and then the first memory card 40 is inserted into the slot 11 of the adapter 1, without the need for any other transmission media such as a computer device or transmission cables. In this embodiment, the portable electronic device 50 is a mobile phone or other equivalent portable electronic devices 50 which are compatible with the adapter interface 20.

Although the present invention has been explained in relation to its preferred embodiment, it is to be understood that many other possible modifications and variations can be made without departing from the spirit and scope of the invention as hereinafter claimed.

What is claimed is:

1. An adapter for a memory card comprising:
a housing comprising a slot for accepting a first memory card to be adapted;
an adapter interface connected to one side of the housing, the adapter interface corresponding to a connection interface of a second memory card, the size of the second memory card being smaller than the size of the first memory card; and
a plurality of terminals disposed in the slot, one end of the terminal set being electrically connected to the adapter interface;
wherein when the memory card is inserted into the slot, the terminal set is electrically connected to the memory card, and the memory card is electrically connected to the adapter interface.

2. The adapter for a memory card as claimed in claim 1, wherein the plurality of terminals is composed of a plurality of metal springs.

3. The adapter for a memory card as claimed in claim 1, wherein the plurality of terminals further comprises a first contact spring portion and a second contact spring portion for respectively electrically connecting to different types of first memory card.

4. The adapter for a memory card as claimed in claim 2, wherein the slot comprises a first containment slot and a second containment slot for accepting different types of first memory cards, a width of the first containment slot being smaller than a width of the second containment slot.

5. The adapter for a memory card as claimed in claim 3, wherein the housing further comprises a fool-proof structure, the fool-proof structure being located between the first containment slot and the second containment slot.

6. The adapter for a memory card as claimed in claim 3, wherein the first contact spring is disposed in the first containment slot.

7. The adapter for a memory card as claimed in claim 3, wherein the second contact spring is disposed in the second containment slot.

8. The adapter for a memory card as claimed in claim 1, wherein the first memory card is attached to the slot in a close fitting manner.

9. The adapter for a memory card as claimed in claim 1, wherein the first memory card is attached to the slot in a fastening manner.

10. The adapter for a memory card as claimed in claim 1, wherein the housing further comprises an indentation for easy removal of the first memory card from the slot.

11. The adapter for a memory card as claimed in claim 1, wherein the second memory card is a Micro SD memory card.

12. The adapter for a memory card as claimed in claim 1, wherein the first memory card is a SD memory card or a Mini SD memory card.
